(19) United States
(12) Patent Application Publication
(10) Pub. No.: US 2013/0220977 A1
(43) Pub. Date: Aug. 29, 2013

(54) ELECTRICAL CONTACT ARRANGEMENT FOR VACUUM INTERRUPTER ARRANGEMENT

(71) Applicant: ABB Technology AG, (US)

(72) Inventors: Dietmar GENTSCH, Ratingen (DE); Tarek LAMARA, Nussbaumen (CH)

(73) Assignee: ABB Technology AG, Zurich (CH)

(21) Appl. No.: 13/849,982

(22) Filed: Mar. 25, 2013

Related U.S. Application Data
(63) Continuation of application No. PCT/EP2011/004774, filed on Sep. 23, 2011.

(30) Foreign Application Priority Data
Sep. 24, 2010 (EP) 10010460.3

(51) Int. Cl. H01H 33/22

(52) U.S. Cl. CPC H01H 33/22
USPC 218/123

(57) ABSTRACT

A vacuum interrupter for a circuit breaker arrangement including a cylindrically shaped insulating part, within which a pair of electrical contact parts are coaxially arranged and concentrically surrounded by the insulating part, wherein the electrical contact parts are arranged for initiating a disconnection arc only between corresponding inner contact elements after starting a disconnection process, and corresponding outer contact elements are arranged for commutating the arc from the inner contact elements to the outer contact elements until the disconnection process is completed wherein each inner electrical contact element is a TMF-like contact element for generating mainly a transverse magnetic field, and each outer electrical contact element is an AMF-like contact element for generating an axial magnetic field.

### RELATED APPLICATION(S)

This application claims priority as a continuation application under 35 U.S.C. §120 to PCT/EP2011/004774, which was filed as an International Application on Sep. 23, 2011 designating the U.S., and which claims priority to European Application EP 10010460.3 filed in Europe on Sep. 24, 2010. The entire contents of these applications are hereby incorporated by reference in their entireties.

### FIELD

The disclosure relates to a vacuum electrical contacts arrangement, for example, a vacuum interrupter arrangement. The vacuum electrical contacts arrangement includes a cylindrically shaped insulating part within which a pair of electrical contact parts are coaxially arranged and concentrical surrounded by the insulating part. The electrical contact parts includes a nominal current conductor with minimum losses between corresponding inner contact elements when the switch is in a closed position, and corresponding outer contact elements including an arc interruptor after starting a disconnection process until the disconnection process is completed. Furthermore, the disclosure relates to contacts part materials and manufacturing process of elements to meet robustness and cost effectiveness.

### BACKGROUND INFORMATION

Vacuum interrupters can be used for medium voltage circuit breakers for applications in the range between 1 and 72 kV of a high current level. These circuit breakers can be used in electrical networks to interrupt short circuit currents as well as load currents under difficult load impedances. The vacuum interrupter can interrupt the current by creating and extinguishing the arc in a closed vacuum container. Modern vacuum circuit breakers can have a longer life expectancy than known air circuit breakers. Nevertheless, the present disclosure is not only applicable to vacuum circuit breakers, but also to modern SF6 circuit breakers having a chamber filled with sulfur hexafluoride gas. Moreover, current interruption with a vacuum is one of the technologies used up to a high voltage level. Modern vacuum circuit breakers can improve the interruption process substantially through reduced contact travel, reduced contact velocity and small masses of moving electrical contact parts. These electrical contact parts can include special contact element arrangements, which are the subject of the present disclosure.

U.S. Pat. No. 4,847,456 discloses a vacuum interrupter having a pair of inner electrical contact parts, which are in the form of RMF (Radial Magnetic Field) contact elements, which are surrounded by outer electrical contact elements. The outer electrical contact elements are connected electrically in parallel, and arranged closely adjacent to the inner electrical contact elements. One of the inner electrical contact elements is mounted such that it can move in the axial direction while the corresponding outer electrical contact element is stationary mounted. Both outer electrical contact elements of the corresponding electrical contact parts are in the form of AMF (Axial Magnetic Field) contact elements. During a disconnection process, a contracting, rotating arc is struck between the inner electrical contact elements and is then commutated from the inner to the outer electrical contact elements. This results in the initially contracting arc between changing to a diffuser which burns between the AMF-like electrical contact elements until it is quenched. This solution allows a high disconnecting rate in a vacuum interrupter chamber.

WO 2006/002560 A1 discloses an electrical contact arrangement and a vacuum interrupter chamber of the type mentioned initially, which also allows an increased switching rate. In particular, a high-short circuit disconnection capacity with a high arc burning voltage is disclosed.

A known contact arrangement for a vacuum interrupter chamber has a pair of inner electrical contact elements which are in the form of RMF contact elements and a pair of outer electrical contact elements. The outer electrical contact elements are connected electrically in parallel with the inner electrical contact elements and are arranged closely adjacent to the inner contact elements. At least one of the inner electrical contact elements is mounted such that it can move axially. The outer electrical contact elements are also in the form of RMF-like contact elements. The inner electrical contact elements are disc-shaped. The inner and the outer electrical contact elements are arranged and designed in such a manner that an arc which is struck during the disconnecting process between the inner electrical contact elements can be commutated entirely or partially between the outer electrical contact elements. That contact arrangement has a low resistance and is able to carry high currents.

As already mentioned, the arc can commutate onto the outer electrical contact elements. Whether one or two arcs burn, depends on the current level. After the disconnection of the initially touching electrical contact elements on load, a concentrated disconnection arc occurs first. As the electrical contact elements open further, a contracted arc can be formed between the contact pieces in the case of an RMF-like contact element. As the contact separation increases further during the course of the disconnecting process, a partial commutation or, with an appropriate physical design, a complete commutation can occur. If the arc, which has been struck between the inner contact pieces, commutates completely onto the outer electrical contact elements, then the interrupter chamber can carry and switch at least the same current as the interrupter chamber with only one RMF-like contact element pair.

The vacuum interrupter chamber which symmetrically surrounds the inner electrical contact parts can be cylindrically shaped. One electrical contact part is mounted such that it can axially move while the corresponding electrical contact part is stationary mounted. The outer electrical contact elements of both electrical contact parts are provided with slots, so that they can form a RMF-like contact element. Thus, when a current is flowing through the outer electrical contact elements, a radially magnetic field can be produced. The inner electrical contact elements of both corresponding electrical contact parts are also RMF-like contact elements and are provided with slots for the same purpose.

The special electrical contact design can increase the production effort substantially. On the other hand it is necessary that the heat arising during the arcing phase is widespread on the electrical contact elements in order to achieve high current interruption performance.

### SUMMARY

A vacuum interrupter for a circuit breaker arrangement, comprising a cylindrically shaped insulating part, within which a pair of electrical contact parts are coaxially arranged within the insulating part and are concentrically surrounded by the insulating part, the electrical contact parts arranged to initiate a disconnection arc only between corresponding inner contact elements after starting a disconnection process, and corresponding outer contact elements arranged to commutate the arc from the inner contact elements to the outer contact elements until the disconnection process is complete, wherein each inner contact element is a TMF-like contact element for generating mainly a transverse magnetic field, and each outer contact element is an AMF-like contact element for generating mainly an axial magnetic field, wherein the outer AMF-like contact element is made as a first part designed as a thin pot-shaped slotted piece in order to create an AMF-field by inversing a slits direction at a bottom contact, and a second part designed as a hollow disk constituting a surface of the outer contact element which is in touch with the plasma arc.

A medium-voltage circuit breaker including a cylindrically shaped insulating part, within which a pair of electrical contact parts are coaxially arranged and are concentrically surrounded by the insulating part, the electrical contact parts arranged to initiate a disconnection arc only between corresponding inner contact elements after starting a disconnection process, and corresponding outer contact elements arranged to commutate the arc from the inner contact elements to the outer contact elements until the disconnection process is complete, wherein each inner contact element is a TMF-like contact element for generating mainly a transverse magnetic field, and each outer contact element is an AMF-like contact element for generating mainly an axial magnetic field, wherein, the outer AMF-like contact element is made as a first part designed as a thin pot-shaped slotted piece in order to create an AMF-field by inversing a slits direction at a bottom contact, and a second part designed as a hollow disk constituting a surface of the outer contact element which is in touch with the plasma arc.

### BRIEF DESCRIPTION OF THE DRAWINGS

FIG. 1 is a longitudinal section through a medium-voltage circuit breaker having a vacuum interrupter arrangement;

FIG. 2 is a schematic longitudinal section view of a first exemplary embodiment according to the disclosure of corresponding electrical contact parts;

FIG. 3 is a schematic longitudinal section view of a second exemplary embodiment according to the disclosure of corresponding electrical contact parts;

FIG. 4 is a schematic front view of a surface of an electrical contact element arrangement;

FIG. 5 is a schematic front view of a surface of an exemplary embodiment of an electrical contact element arrangement;

FIG. 6 is a longitudinal section view of a double contact system of a vacuum interrupter of an exemplary embodiment of the disclosure;

FIG. 7 is a longitudinal section view of a single contact system of a vacuum interrupter of an exemplary embodiment of the disclosure;

FIG. 8 is a longitudinal section view to a single electrical contact part with, an inner TMF-like contact element combined with an outer AMF-like contact element;

FIG. 9 is a front view of a surface of an outer electrical contact element in the first exemplary embodiment; and

FIG. 10 is a front view on the surface of an outer electrical contact element in the second exemplary embodiment.

### DETAILED DESCRIPTION

Exemplary embodiments of the disclosure provide a vacuum interrupter for a circuit breaker arrangement with an easy process to manufacture a pair of electrical contact parts for a high switching performance.

According to exemplary embodiments of the disclosure, each inner electrical contact element can be designed as a pin or butt contact element for conducting the nominal current (the service current), or TMF-like (Transverse Magnetic Field) contact element for generating mainly a transverse magnetic field or AMF-like (axial magnetic field) for generating enhancing axial magnetic field, and each outer electrical contact element is designed as an AMF-like (Axial Magnetic Field) contact element for generating mainly an axial magnetic field.

The specific combination of these electrical contact elements can ensure the lowest load current losses when the switch is in a closed position, lower than in the known AMF vacuum interrupters, and high current interruption performance while opening the switch under short circuit current conditions. Moreover, the electrical contact elements according to exemplary embodiments of the disclosure can be relatively easy to manufacture. Furthermore, the special electrical contact element combination can provide the electro-physical effect that the plasma density during the arcing phase is lowered by the effect of the axial magnetic field and the wide effective arcing zone so the heat can be widespread on the contact surfaces reducing the erosion rates. Moreover, the special electrical contact elements according to exemplary embodiments of the disclosure provide the physical robustness and compactness to and increase the life time of the vacuum interrupter.

The contacts can be arranged in a way to make the initial arcing phase and the subsequent arcing phase decoupled. Here only the inner contacts are touching when the switch is in a closed position, and the initial arc starts first between the initially touching inner contacts parts, and then commutates to the outer contacts parts during the disconnection process until the arc is distinguished. Due to the lower voltage necessary for the arc to sustain on the AMF-like contact element, the arc can at least partly commutate.

The contacts can be arranged in another way such that the arc starts between the outer contacts parts immediately after contacts separate and develop in the diffuse mode as with AMF-like contacts. Here all inner and outer contacts parts are touching in the closed position but the load current flows preferentially through the inner contact due to the high conductivity of the inner contact material and due to the low contact resistance. In such an arrangement, the contact resistance of the inner contacts in the closed position is lower than the outer contacts because the axial mechanical closing forces press mainly the inner part due to the elastic effect of the outer contacts coils which are slightly bended outwards. While opening, due to the same elastic effect, the high speed opening forces first separate the inner contacts parts and then the outer contacts parts which have been bended inward for a short time.

The inner contact element of each electrical contact part can have a plane, pin or butt form for at least load current conduction or be spiral- or star-shaped for the same function and for supporting the transverse magnetic field. The inner contact element can be made of a material with high electrical conductivity, for example: Cu, CuCr, or other suitable Cu-alloys.

In contrast, the outer AMF-contact element of each electrical contact part can include an electrical coil for generating a strong axial magnetic field in order to achieve a significant electro-physical effect as described above. The outer contact element can be made from two different parts. The first part is designed as a thin cup-slotted piece in such a way to create an AMF field by inversing the slits direction at the bottom contact. This piece can be made from a kind of stainless steel or any other conductive hard material to meet the robustness and cost effectiveness criteria. The thickness of this part should be small in order to provide a large AMF zone between the electrodes and hence a larger electrode area for the diffuse arc, and a small contact mass (small weight). The second part of the outer contact element can be made of the same material as the inner part with high electrical conductivity, or similar conductive alloy having higher resistance to erosion. This part can be designed as a hollow disc with a large area and constitutes the surface of the outer contact which is in touch with the plasma arc.

According to an exemplary embodiment of the disclosure, the inner electrical contact element of each electrical contact part can be coaxially arranged within the corresponding outer electrical contact element, which has a pot-shaped or a tube-shaped geometrical form. Intermediate forms are also possible for that special coaxial arrangement. The pot-shape of the outer electrical contact element can be formed by pressing a flat metallic sheet of steel having a thickness in a range between 3 to 9 Millimeters, for example, 4 to 6 Millimeters. This special production method presents a significant advantage in terms of manufacturing process, especially in time.

Both different electrical contact elements can be attached to a common contact rod as a support element in various ways.

According to a first exemplary embodiment of the disclosure, a single contact system is provided. On one electrical contact part, the inner electrical contact element is arranged stationary in relation to the outer electrical contact element and on the other electrical contact part only the inner electrical contact element is arranged to be moveable in relation to the outer electrical contact element and in relation to the corresponding electrical contact part. Thus, both corresponding outer AMF-like contact elements can be fixed closely adjacent one to another inside the insulating part forming a constant intermediate gap. The inner electrical contact element and the outer electrical contact element can be separately attached to the distal end of a common contact rod. The contact rod is fixed to the housing of the vacuum interrupter.

According to a second exemplary embodiment of the disclosure, a double-contact system can be realized in that on both corresponding electrical contact parts the inner electrical contact element is stationary arranged in relation to the outer electrical contact element. At least one of both electrical contact parts is moveably mounted in relation to the surrounding insulating part in order to form an electrical switch operated by manual or automatic switch operation, as such an electro-magnetic actuator.

For the second exemplary embodiment, the double contact parts can be arranged in two ways, first in such a way that only inner contact parts are in touch when the switch is in a closed position and the outer parts are separated with a small distance. While opening the inner contacts include the last touching points.

In the second arrangement, both contact inner parts and outer parts can be touching when the switch is in closed position. While opening, the outer contacts include the last touching points due to their slight elastic deformation.

In order to form a closed vacuum chamber for accommodating the pair of electrical contact parts, the insulating part can include a cover plate on each front side. Both cover plates can also serve as a mechanical support for contact rods as mentioned above.

An additional barrel-shaped metal or ceramic shield can be arranged coaxially between the insulating part and the inner pair of electrical contact parts. That shield can avoid a formation of a metallic layer on the inside of the inner wall of the insulating part in connection with the special electrical contact pieces according to the present disclosure.

The foregoing and other aspects of the disclosure will become apparent following the detailed description of the disclosure when considered in conjunction with the enclosed drawings.

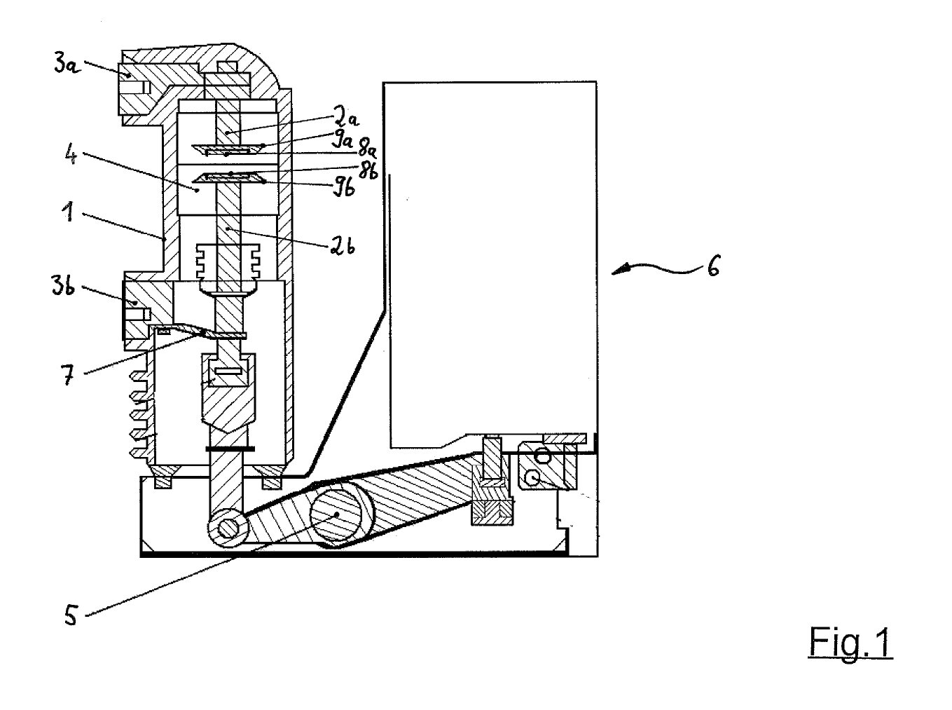

The medium voltage circuit breaker as shown in FIG. 1 includes an insulating part 1 of a vacuum interrupter within which a pair of electrical contact parts 2a, 2b is coaxially arranged. A stationary electrical contact part 2a corresponds with a moveable electrical contact part 2b. Both electrical contact parts 2a and 2b have corresponding outer electrical connectors 3a and 3b respectively and they form an electrical switch for electrical power interruption inside a vacuum chamber 4 of the insulating part 1.

The moveable electrical contact 2b is moveable between the closed and the opened position via a jackshaft 5. The jackshaft 5 internally couples the mechanical energy of an electromagnetic actuator 6 to the moving electrical contact 2b inside the insulating part 1. In order to ensure an electrical connection between the moveable electrical contact part 2b which is moveably attached to the electro-magnetic actuator 6, a flexible connector 7 is provided between the moveable electrical contact part 2b and the outer electrical connector 3b.

According to an exemplary embodiment of the present disclosure, each electrical contact part 2a and 2b can include two different kinds of contact elements. An inner electrical contact element 8a; 8b can be designed as a TMF-like contact element and each corresponding outer electrical contact element 9a; 9b can be designed as an AMF-like contact element.

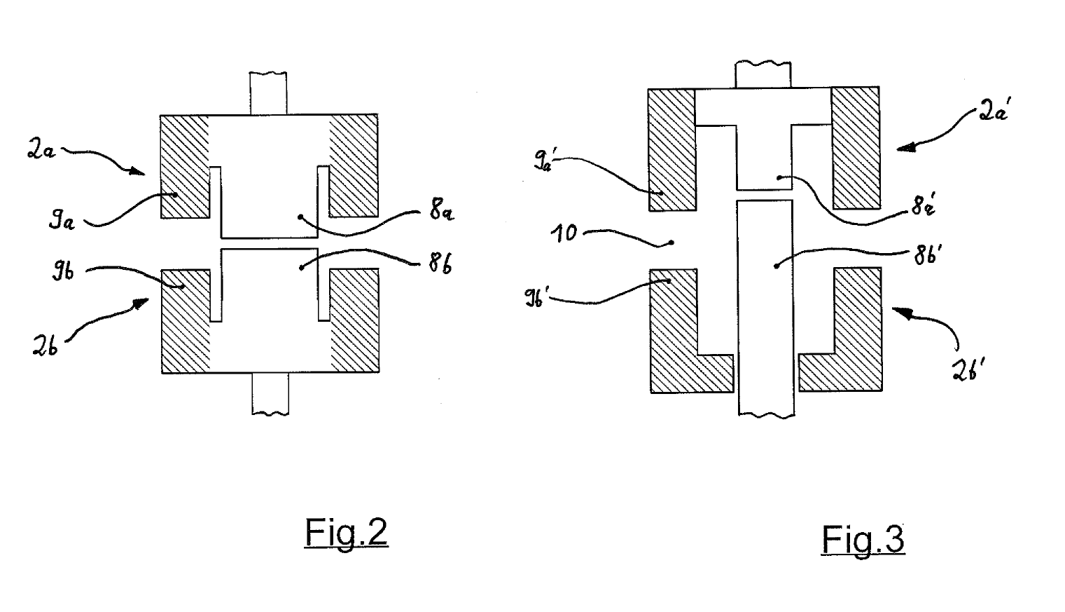

According to FIG. 2, a double-contact system can be realized. On both corresponding electrical contact parts 2a and 2b, the inner electrical contact elements 8a and 8b, respectively, are arranged stationary in relation to the outer electrical contact elements 9a and 9b respectively. Each inner electrical contact element 8a, 8b is coaxially arranged within the corresponding outer electrical contact element 9a, 9b. The outer electrical contact elements 9a, 9b have a pot-shaped geometrical form in order to accommodate the respective inner electrical contact elements 8a and 8b ensuring an insulation gap between the inner and the outer electrical contact elements 8a and 9a or 8b and 9b.

According to FIG. 3, a single contact system can be provided, wherein on one electrical contact part 2a′ the inner electrical contact element 8a′ is arranged stationary in relation to the corresponding outer electrical contact element 9a′. In contrast, on the other electrical contact part 2b′ only the inner electrical contact element 8b′ is moveably arranged in relation to the outer electrical contact element 9b′ and in relation to the corresponding electrical contact part 2b′. Both corresponding outer AMF-like contact elements 9a′ and 9b′ are fixed closely adjacent one to another inside the insulating part forming a constant intermediate gap 10 which is independent of the switching position of the vacuum interrupter.

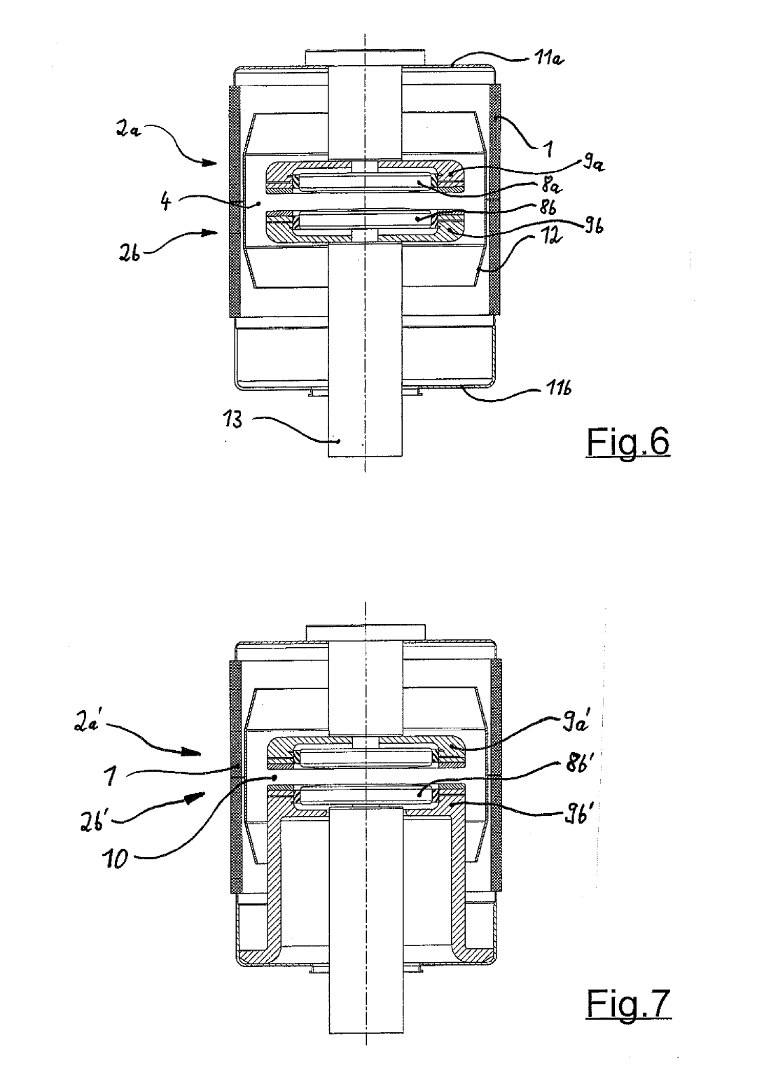

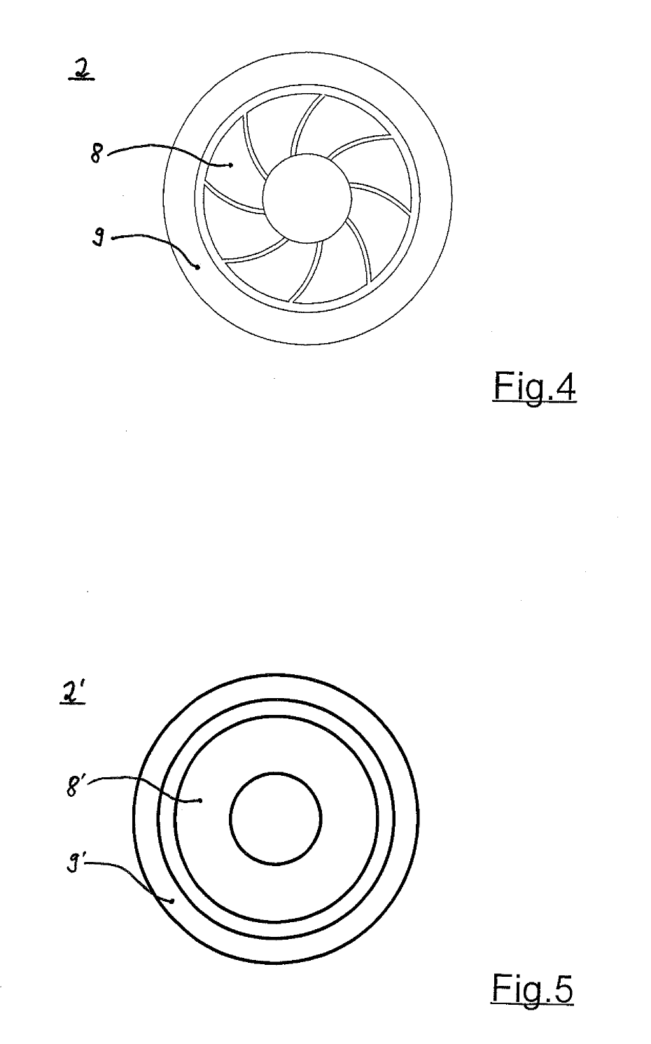

Referring to the schematic FIG. 4 on an electrical contact part 2, the inner electrical contact element 8 has a TMF-like geometry for providing the transverse magnetic field. The corresponding outer electrical contact element 9 is ring-shaped in order to provide an axial magnetic field.

Alternatively, according to FIG. 5 an electrical contact part 2′ has an inner TMF-like contact element 8′ with a plane-shaped form which corresponds to an outer AMF-like electrical contact element 9′ which is identical to the foregoing described exemplary embodiment.

As shown in FIG. 6, the cylindrically-shaped insulating part 1 of the vacuum interrupter includes cover plates 11a and 11b which are arranged on both front sides of the insulating part 1 in order to form a closed vacuum chamber 4. Inside the vacuum chamber 4, a pair of electrical contact parts 2a and 2b is arranged. The first electrical contact part 2a is fixed in relation to the insulating part 1. The corresponding electrical contact part 2b is moveably arranged in relation to the insulating part 1 in order to form an electrical switch. For moving the electrical contact part 2b the corresponding contact rod 13 is operated by an electromagnetic actuator. Furthermore, a barrel-shaped metal shield 12 is coaxially arranged inside the vacuum chamber 4.

A double contact system is provided which includes inner electrical contact elements 8a and 8b respectively which are arranged stationary in relation to corresponding outer electrical contact elements 9a and 9b respectively. The outer electrical contact elements 9a and 9b have a pot-shaped geometrical form in order to accommodate the corresponding inner electrical contact elements 8a and 8b respectively in an insulated manner.

According to FIG. 7, a single contact system is illustrated. The upper electrical contact part 2a′ is stationary mounted in relation to the insulating part 1. In contrast, on the other electrical contact part 2b′, only the inner electrical contact element 8b′ is moveably arranged in relation to its corresponding outer electrical contact element 9b′. Thus, for electrically switching only the inner electrical contact element 8b′ moves axially. Between the corresponding outer electrical contact elements 9a′ and 9b′ a constant intermediate gap 10 is provided.

When the inner electrical contact elements 8a′, 8b′ are in a closed position, the load current flows through them with low contact resistance. For current interruption, the initial arc is generated between the inner TMF-like contact elements 8a′, 8b′ and develops shortly in transition modes as in standard spiral TMF-like contact elements depending on the current level. At low current, the arc column expands in a diffuse mode with increasing the gap distance and the instantaneous current as well. At high current, the generated transverse magnetic field by the spirals makes the constricted arc rotating shortly between the inner contacts elements 8a′, 8b′. The arc should reach the inter-electrode gap between inner and outer contacts after a short time of a few Milliseconds, and then can to commutate entirely to the outer AMF-like contact elements 9a′ and 9b′ and remains in diffuse mode until the arc extinction. This idea is supported by the fact that the arc voltage drop through AMF-like contact elements 9a′ and 9b′ is distinctly smaller than through TMF-like contact elements 8a′ and 8b′.

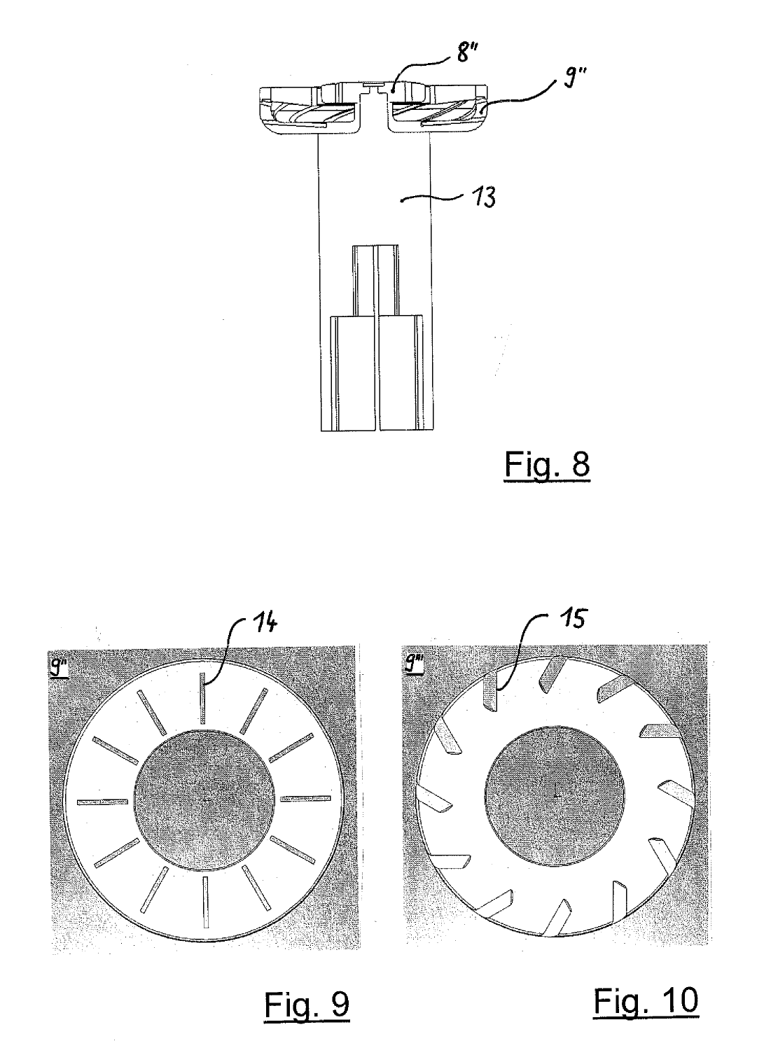

FIG. 8 shows a longitudinal section view to a single electrical contact part which includes an inner TMF-like contact element 8″ combined with an outer AMF-like contact element 9″ on a contact rod 13.

In FIGS. 9 and 10 two different surfaces of an outer electrical contact elements 9″ and 9′″ respectively are shown. According to FIG. 9 vertical slits 14 are provided through the sheet material. FIG. 10 shows inclined slits 15 substantially radial arranged in circumference direction. The goal of designing the outer contact elements 9″ and 9′″ with a thin pot-shape layer and a large ring plate is to make the generated AMF covering a larger electrode area to ensure a large arc distribution. Tests of the axial magnetic field (AMF) for both outer contact exemplary embodiments have shown a significant advantage of the second exemplary embodiment. The axial magnetic strength is practically twice than in the first exemplary embodiment.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCE LIST

1 insulating part
2 electrical contact part
3 electrical connector
4 vacuum chamber
5 jackshaft
6 electromagnetic actuator
7 flexible connector
8 inner contact element
9 outer contact element
10 intermediate gap
11 cover plate
12 shield
13 contact rod
14 vertical slit
15 inclined slit

What is claimed is:

1. A vacuum interrupter for a circuit breaker arrangement, comprising:
a cylindrically shaped insulating part;
a pair of electrical contact parts are coaxially arranged within the insulating part and are concentrically surrounded by the insulating part, the electrical contact parts arranged to initiate a disconnection arc only between corresponding inner contact elements after starting a disconnection process, and corresponding outer contact elements arranged to commutate the arc from the inner contact elements to the outer contact elements until the disconnection process is complete, wherein each inner contact element is a TMF-like contact element for generating mainly a transverse magnetic field, and each outer contact element is an AMF-like contact element for generating mainly an axial magnetic field,
wherein,
the outer AMF-like contact element is made as a first part designed as a thin pot-shaped slotted piece in order to create an AMF-field by inversing a slits direction at a bottom contact, and a second part designed as a hollow disk constituting a surface of the outer contact element which is in touch with the plasma arc.

2. The vacuum interrupter according to claim 1, the outer AMF-like contact element comprising:
an electrical coil for generating the axial magnetic field.

3. The vacuum interrupter according to claim 1,
wherein slots of the outer AMF-like contact element are extended into the second part (hollow disk) for creating a stronger AMF-field, and for reducing the effect of Eddy currents.

4. The vacuum interrupter according to claim 1,
wherein the second part (hollow disk) constituting the surface of the outer contact element is slotted in different ways to order to reduce the effect of Eddy currents.

5. The vacuum interrupter according to claim 1, the inner TMF-like contact element comprising:
a plane, pin, butt, star or spiral shaped form for supporting or generating the transverse magnetic field.

6. The vacuum interrupter according to claim 1,
wherein the pot-shape of the outer contact element is formed by a pressed flat metallic sheet of steel or other hard conductive material having a thickness in a range between 3 to 9 Millimeters.

7. The vacuum interrupter according to claim 3,
wherein the inner contact element and the outer electrical contact element are separately attached to the distal end of a common contact rod.

8. The vacuum interrupter according to claim 1,
wherein one of the inner and outer contact elements is at least partly movably mounted in relation to the surrounding insulating part in order to form an electrical switch operatable by manual or automatic switch operation.

9. The vacuum interrupter according to claim 1,
wherein for a double-contact system on the inner and outer contact elements, the inner contact element is arranged stationary in relation to the outer contact element.

10. The vacuum interrupter according to claim 9,
wherein in case the switch is in a closed position, both corresponding inner contact parts are in touch, and both outer AMF-like contact elements are fixed closely adjacent one to another inside the insulating part forming a small intermediate gap.

11. The vacuum interrupter according to claim 9,
wherein in case the switch is in a closed position both corresponding inner contact parts and both outer AMF-like contact elements are in touch.

12. The vacuum interrupter according to claim 1, wherein each inner electrical contact element is designed as a TMF-like contact element for generating mainly a transverse magnetic field, and each outer electrical contact element is designed as TMF-like contact element for generating mainly an transverse magnetic field; and
a similar geometry holds in case of TMF-TMF contacts arrangements by inversing the slits of the outer contact element and increasing the inner contact element diameter and decreasing the outer contact element disk area.

13. The vacuum interrupter according to claim 1, the insulating part comprising:
a cover plate on each front side in order to form a closed vacuum chamber for accommodation the pair of contact elements.

14. The vacuum interrupter according to claim 1, comprising:
an additional barrel-shaped metal or ceramic shield coaxially arranged between the insulating part and the pair of contact elements.

15. A medium-voltage circuit breaker including at least one pole part operated by an electromagnetic actuator as a switch operator comprising:
a cylindrically shaped insulating part;
a pair of electrical contact parts are coaxially arranged within the insulating part and are concentrically surrounded by the insulating part, the electrical contact parts arranged to initiate a disconnection arc only between corresponding inner contact elements after starting a disconnection process, and corresponding outer contact elements arranged to commutate the arc from the inner contact elements to the outer contact elements until the disconnection process is complete, wherein each inner contact element is a TMF-like contact element for generating mainly a transverse magnetic field, and each outer contact element is an AMF-like contact element for generating mainly an axial magnetic field,
wherein,
the outer AMF-like contact element is made as a first part designed as a thin pot-shaped slotted piece in order to create an AMF-field by inversing a slits direction at a bottom contact, and a second part designed as a hollow disk constituting a surface of the outer contact element which is in touch with the plasma arc.
